(19) United States
(12) Patent Application Publication
(10) Pub. No.: US 2004/0122976 A1
(43) Pub. Date: Jun. 24, 2004

(54) Integrated mobility management

(76) Inventors: Ashutosh Dutta, Bridgewater, NJ (US); Henning Schulzrinne, Leonia, NJ (US); Kuok-Shoong Wong, Eastontown, NJ (US); James Burns, Whippany, NJ (US); Anthony McAuley, Glen Ridge, NJ (US); Ken Young, Denville, NJ (US); Ravi Jain, Mountain View, CA (US)

Correspondence Address: Glen Farbanish, Telcordia Technologies, Inc., One Telcordia Drive 5G116, Piscataway, NJ, 08854-4157, US

(21) Appl. No.: 10/694,199

(22) Filed: Oct. 24, 2003

Related U.S. Application Data
(60) Provisional application No. 60/421,031, filed on Oct. 24, 2002.

(51) Int. Cl. G06F 15/16; H04Q 7/20

(52) U.S. Cl. 709/245; 455/436

(57) ABSTRACT

Integrated mobility management mechanisms monitor a mobile host's degree of mobility and the applications it executes. Mobile hosts move between wireless-access, micro-mobility domains interconnected through a backbone network. While the mobile host is stationary, MIP-LR and SIP systems operate to ensure TCP and RTP/UDP packets, respectively, traveling to/from the mobile host are properly routed through the backbone to the host's current domain. An MMP system routes packets through this domain. As the host moves within a domain, the MMP system updates the domain routing to the mobile host's new location. As the mobile host moves between domains, the host obtains a new IP address and the MMP system establishes routing within the new domain to the mobile host's new location. In addition, the MIP-LR and SIP systems activate to ensure the TCP and RTP/UDP packets, respectively, are automatically re-routed through the backbone to the new domain.

### RELATED APPLICATION

The present application claims the benefit of U.S. Provisional Application No. 60/421,031 filed on Oct. 24, 2002, entitled “Integrated Mobility Management.”

### GOVERNMENT LICENSE RIGHTS

This invention was made with Government support under Agreement No. MDA972-00-9-0009 awarded by DARPA. The Government has certain rights in the invention.

### BACKGROUND OF OUR INVENTION

1. Field of the Invention

Our invention relates generally to mobility management. More particularly, our invention relates to methods and apparatus for integrated mobility management that manages both intra-domain and inter-domain mobility for both real-time and non-real time applications.

2. Description of the Background

Mobility in IP (Internet Protocol) based networks has become increasingly popular for both commercial and battlefield networks. Under IP-based networking, each host is identified by a unique IP address that is used for locating the host for packet routing purposes. Accordingly, an inherent issue with mobility is that the IP address assigned to a mobile host must change as the mobile host moves between sub-networks so that data packets can continue to be properly routed. In general, mobility management oversees the changing of IP addresses and ensures that mobile hosts can be quickly located such that packet delivery continues to properly operate in the presence of mobility without affecting ongoing communications.

The cornerstone solution to mobility management is Mobile IP (MIP). Under MIP, a mobile host is identified by a permanent IP address associated with a home network. As the mobile host moves to a new sub-network, it obtains a temporary care-of-address that is used for packet routing purposes to locate the mobile host. However, regardless of the sub-network through which the mobile host is currently “attached”, the mobile host always maintains its identity by its permanent home network address. More specifically, each time a mobile host moves, it registers (re-registers) a new care-of-address with a home agent in its home network. Correspondent hosts (note that correspondent host refers to network elements to which a mobile host is communicating) communicating with the mobile host continue to send packets to the permanent IP address, which packets are intercepted by the home agent and tunneled to the mobile host using the care-of-address. This process is referred to as triangular routing through encapsulation and allows the mobile host to maintain transparent network connectivity during mobility, which transparency is essential for non-real-time applications using connection-oriented protocols such as TCP (Transmission Control Protocol). Unfortunately, triangular routing and encapsulation increase the communications latency between mobile and correspondent hosts and increases network load. In addition, MIP is unacceptable to delay sensitive real-time traffic such as RTP (Real Time Protocol)/UDP (User Datagram Protocol) traffic (e.g., video, voice, etc.). MIP with Route Optimization has been proposed as one solution that resolves some aspects of the triangular routing problem; however, route optimization requires modifications to an operating system's TCP/IP stack and has inherent delays associated with notifying a correspondent host whenever a mobile host moves, again creating issues for real-time applications.

In response to the drawbacks associated with MIP regarding real-time applications, SIP (Session Initiation Protocol) based mobility management has been proposed (see “Application-Layer Mobility Using SIP,” by Henning Schulzrinne and Elin Wedlund, and see “Mobility Support using SIP,” by the same authors). In accordance with SIP, the mobile host does not maintain an association with a home network through a permanent IP address. Rather, the mobile host is associated with a URL (uniform resource locater). A SIP server (e.g., a SIP registration server) within a home network maps the URL to an IP address, which changes each time the mobile host moves into a new sub-network. As such, each time the mobile host moves, it notifies the SIP server of its new IP address such that any new correspondent host can locate the mobile host. Additionally, the mobile host directly sends its new IP address to any correspondent hosts to which it is currently conducting communications. These current correspondent hosts immediately switch to the new IP address and continue to directly communicate with the mobile host, bypassing the need for triangular routing. As a result, SIP based mobility removes the network delays associated with MIP making SIP based mobility well suited for real-time applications. However, because the mobile host and correspondent hosts allow the mobile host's IP address identity to change, SIP based mobility cannot be used for non-real time connection-oriented applications. Hence, Schulzrinne and Wedlund propose integrating MIP and SIP based mobility to address the needs of both non-real-time and real-time applications. However, these combined architectures fail to address the extra signaling load and latency associated with MIP and require modifications to the operating system so that the network traffic can be properly discerned and the mobility protocols can be properly applied.

In addition, the MIP and SIP based mobility schemes each has a further disadvantage. Specifically, when a mobile host rapidly moves between base stations and sub-networks, the mobile host can potentially generate a high signaling load as it updates its IP address through MIP and SIP registration processes. This signaling load is not localized and affects the entire network performance. This performance issue becomes worse when many mobile hosts are rapidly moving between sub-networks. Additionally, the registration process also affects the performance of the mobile host (e.g., obtaining new IP addresses, communicating with servers and correspondent hosts, etc.). This issue has been referred to as a micro-mobility/macro-mobility issue. Specifically, mobility management schemes, such as HAWAII and Cellular-IP, have been proposed with respect to MIP in which the wireless access network is sub-divided into micro-mobility regions (referred to as domains) interconnected by a backbone network. While within a domain (referred to as micro-mobility movement), a mobile host maintains a single care-of-address as the mobile host moves between base stations. Registration with the MIP home agent is never triggered. The care-of-address routes packets to the domain. The micro-mobility protocol, which is a low latency local signaling protocol, maintains routing within the domain such that packets can be properly routed through the domain to/from the mobile host as the host moves between base stations. However, whenever a mobile host moves between domains (referred to as macro-mobility movement), the mobile host obtains a new care-of-address and re-registration is performed with the home agent through MIP.

While combined micro-mobility (e.g., HAWAII and Cellular-IP) and MIP-based solutions exist, these solutions fail to address real-time traffic and continue to suffer from the disadvantages of MIP, as defined above. In addition, the micro-mobility domains, as defined under the micro-mobility solutions, are hierarchical in nature, making domains susceptible to node and link failures.

### SUMMARY OF OUR INVENTION

It is desirable to have methods and apparatus that overcome the disadvantages of prior-art mobility management systems and allow for integrated mobility management addressing both intra-domain and inter-domain mobility for both real-time and non-real time applications. In accordance with our invention, as a mobile host moves, it invokes one or more integrated mobility management schemes in accordance with the scope/degree of mobility and the types of applications it is executing.

Specifically, our invention applies to a network of wireless access sub-networks interconnected by a backbone network. Each wireless access sub-network further comprises one or more domains, referred to as micro-mobility domains. As a mobile host moves within a sub-network either within or between domains, it makes micro-mobility movements and when it moves between sub-networks, it makes macro-mobility movements. Our invention is a micro-mobility management system, we refer to as MMP, and the policy-based integration of this system with two macro-mobility management systems including SIP and a system we refer to as application layer MIP-LR (hereinafter MIP-LR). MMP manages a mobile host's micro-mobility movements within/between the domains of a sub-network and prevents a mobile host from having to re-acquire a new care-of-address during these types of movements, leaving a mobile host's real-time communications and non-real-time connection oriented communications unaffected by the move. When a mobile host makes a macro-mobility movement, MMP manages the movement to the new domain and the acquiring of a new care-of-address. The MIP-LR system then activates to manage the mobility on behalf of the connection-oriented communications at the mobile host, thereby ensuring these communications continue unaffected by the move. Similarly, the SIP system activates on behalf of the real-time communications at the mobile host, again ensuring these communications continue unaffected by the move.

In particular, a mobile host has a permanent IP address, which non-real-time applications use to reference the mobile host, and a SIP URL, which real-time applications use to reference the mobile host. In addition, the mobile host is configured with a care-of-address, which constantly updates as the mobile host moves between sub-networks. The care-of-address provides for the actual routing of packets through the backbone network to/from the sub-network/domain in which the mobile host is currently located. The MMP system manages the actual routing of packets within a domain to/from the mobile host.

Specifically, each domain runs the MMP protocol to establish routes within the domain. Advantageously, this protocol also allows for redundancy, thereby overcoming issues associated with traditional hierarchical micro-mobility systems. In addition, each mobile host runs a MMP daemon that monitors a mobile host's movement within and between domains. When detecting intra-domain movements, the daemon updates the domain routing such that packets continue to be properly routed through the domain to the mobile host. However, the MMP daemon does not force the mobile host to update its current care-of-address and as such, real-time and non-real-time communications at the mobile host continue to operate unaffected by the movement. On the contrary, when detecting an inter-domain movement between sub-networks, the MMP daemon registers with the new domain to establish new routing within the domain and also forces the mobile host to obtain a new care-of-address so that packets are properly routed through the backbone network to the new sub-network. Because the care-of-address changes, real-time and non-real-time communications at the mobile host are now affected.

Accordingly, our invention also comprises the MIP-LR and SIP systems to manage these communications. Specifically, each mobile and correspondent host executes a MIP-LR sub-system (in particular, a sub-system that discerns between real-time and non-real-time packets and captures and modifies only the IP packets related to the non-real-time communications). Non-real-time applications at a mobile host and a correspondent host reference the mobile host using the mobile host's permanent IP address, thereby giving these applications a constant reference point. The MIP-LR sub-systems at the mobile and correspondent hosts in turn modify the IP packets these applications generate, swapping between the mobile host's permanent IP address and care-of-address based on the direction of the packets. This swap ensures the packets are properly routed through the network and also ensures the applications reference the communications through the permanent IP address. In addition, the swap occurs unknown to the applications. When the MMP daemon updates the mobile host's care-of-address, the MIP-LR sub-system at the mobile host detects the change and conveys this change to the MIP-LR sub-system at the correspondent host. The MIP-LR sub-systems then uses the new care-of-address, leaving the permanent IP address from the perspective of the applications unchanged. This automatic update/swap allows the packets of the non-real-time communications to continue to be properly routed and also allows the non-real-time communications to continue unaffected by the movement. As important, our MIP-LR system avoids the shortcomings associated with triangular routing.

Similarly, each mobile and correspondent host executes a SIP sub-system. Real-time applications at a mobile and correspondent host reference the mobile host using its SIP URL, which is translated to the mobile host's current care-of-address at the start of real-time communications. When the MMP daemon updates the mobile host's care-of-address, the SIP sub-system at the mobile host detects the change and conveys this change to the SIP sub-system at the correspondent host, which automatically updates the real-time-applications to use the new care-of-address. Accordingly, the packets of the real-time communications continue to be properly routed between the mobile and correspondent hosts, unaffected by the movement. Importantly, the MIP-LR system discerns between real-time and non-real-time packets, leaving the real-time packets unaffected. In addition, our MIP-LR and SIP systems are integrated without modification to the mobile and correspondent host operating systems.

Hence, our invention detects the types of traffic a mobile host is running and the types of movements the mobile host makes and addresses the mobility with an appropriate mobility mechanism. Significantly, our integrated mobility management system addresses both micro-mobility and macro-mobility movements while also addressing the real-time and non-real communications.

### BRIEF DESCRIPTION OF THE DRAWINGS

FIG. 1 is a high-level exemplary network architecture to which our integrated mobility management system applies, the network comprising sub-networks of micro-mobility domains interconnected by a backbone network.

FIGS. 2A-2C are exemplary network architectures of micro-mobility domains to which our micro-mobility management system, MMP, is applicable.

FIG. 3 depicts an illustrative embodiment of the MMP architecture of our invention resident at mobile hosts wherein MMP manages a mobile host's micro-mobility movements both within and between domains.

FIGS. 4A-C depict a flow chart of our integrated mobility management method executed at a mobile host as the host makes micro-mobility movements within domains and macro-mobility movements between domains and simultaneously manages both real-time and non-real-time communications.

FIG. 5 is an exemplary message flow of our MMP management system, wherein a mobile host causes the flow as it moves both within and between micro-mobility domains.

FIG. 6 depicts an illustrative embodiment of the MIP-LR architecture of our system integrated with the MMP architecture of FIG. 3, wherein the MIP-LR architecture manages non-real-time communications between mobile and correspondent hosts as the mobile host makes macro-mobility movements between domains.

FIG. 7 is an illustrative non-real-time communication between applications at a mobile host and a correspondent host and shows how the MIP-LR system manipulates IP addresses to ensure the non-real-time communication continues uninterrupted as the mobile host makes macro-mobility movements between domains.

FIG. 8 is an exemplary integrated message flow of our integrated MMP management system and MIP-LR system, wherein a mobile host causes the flow as it moves both within and between micro-mobility domains and maintains a non-real-time communication with a correspondent host.

FIG. 9 an illustrative embodiment of the SIP architecture of our system integrated with the MMP and MIP-LR architectures of FIG. 6, wherein the SIP architecture manages real-time communications between mobile and correspondent hosts as the mobile host makes macro-mobility movements between domains.

FIG. 10 is an exemplary integrated message flow of our integrated MMP management system, MIP-LR system, and SIP system wherein a mobile host causes the flow as it moves both within and between micro-mobility domains and maintains both real-time and non-real-time communications with a correspondent host.

### DETAILED DESCRIPTION OF OUR INVENTION

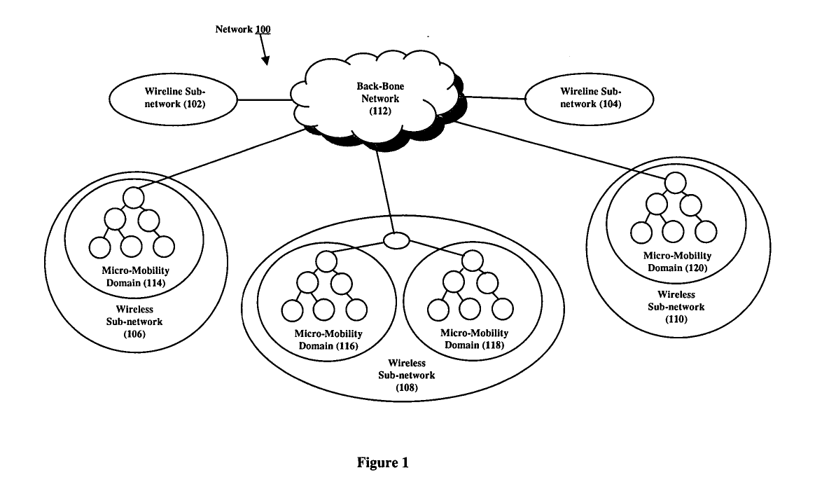

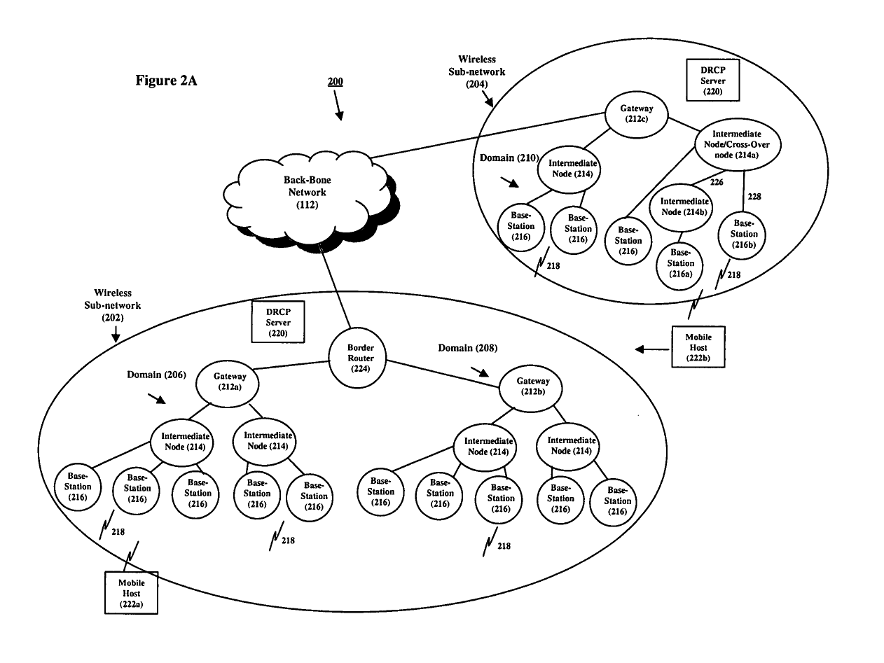

Our invention is an integrated multi-layered mobility management system for both intra-domain and inter-domain mobility by a mobile host that addresses both non-real-time connection-oriented traffic and real-time traffic. FIG. 1 shows an exemplary network 100 to which our invention applies. Network 100 comprises a plurality of sub-networks 102, 104, 106, 108, and 110 interconnected by a backbone network 112. The sub-networks are either wire-line networks 102 and 104 or wireless access networks 106, 108, and 100, the wireless access networks being of particular concern here. Each wireless sub-network comprises one or more domains 114, 116, 118, and 120, referred to as micro-mobility domains. A mobile host makes micro-mobility movements when it moves within a domain, such as domain 114, or between domains within the same sub-network, such as between domains 116 and 118. A mobile host makes macro-mobility movements when it moves between domains of different sub-networks, such as between domains 114 and 116 or between domain 118 and 120. Our invention is a micro-mobility management system, which we refer to as MMP, and the policy-based integration of this system with two macro-mobility management systems including SIP (as described by Henning Schulzrinne and Elin Wedlund in, “Application-Layer Mobility Using SIP” and “Mobility Support using SIP”) and a system we refer to as application layer MIP-LR (hereinafter MIP-LR). MMP manages a mobile host's micro-mobility movements and prevents a mobile host from having to re-acquire and re-register a new care-of-address each time it makes small movements. As a result, the mobile host's real-time communications (i.e., RTP and UDP) and non-real time communications (i.e., TCP) avoid the latency issues associated with updating the network with new addresses. Similarly, the network is not flooded with signaling overhead messages. When a mobile host does make a macro-mobility movement, MMP manages the movement to the new domain and the acquiring of a new care-of-address. However, because the mobile host acquires a new care-of-address during the macro-mobility movement, the integrated SIP and MIP-LR components are activated. Advantageously, SIP manages the mobility for the delay sensitive real-time communications and MIP-LR manages the mobility for the non-real-time connection-oriented communications. Importantly, while MIP-LR maintains the connectively for connection-oriented communications like MIP, it also overcomes the triangular routing issues associated with MIP. Hence, our invention detects the types of traffic a mobile host is running and the types of movements the mobile host makes and addresses the mobility with an appropriate mobility mechanism.

More specifically, in accordance with our invention, a mobile host is associated with three addresses: a permanent IP address, a care-of-address during mobility, and a SIP URL. Connection-oriented applications at both the mobile host and at remote stationary host to which the mobile host is communicating reference the mobile host through the permanent IP address in order to establish connection-oriented communications (hereinafter, the remote stationary hosts to which a mobile host communicates are referred to as correspondent hosts). In accordance with SIP, every host (i.e., both mobile hosts and correspondent hosts) has a corresponding SIP URL. A real-time application uses the SIP URL to reference a far-end host/application in order to establish a real-time session. Nonetheless, the actual routing of packets to a mobile host, whether for non-real-time or for real-time communications, occurs through the care-of-address. In particular, as the mobile host moves between the sub-networks of network 100, its interface is reconfigured with a new care-of-address. While MMP mechanisms handle the routing of packets within the domain to which the mobile host is currently attached, the care-of-address is used to route packets to/from this domain based on traditional packet routing mechanisms. On top of this physical routing, MIP-LR provides a mechanism on behalf of the connection-oriented applications that maps between the permanent IP address and the care-of-address as the mobile host moves, hiding the care-of-address from these applications and thereby allowing the connection-oriented communications to remain established during mobility. Similarly, SIP provides a mechanism for real-time applications that maps between the SIP URL and the care-of-address as the mobile host moves. The following will describe in further detail MMP, MIP-LR, and SIP and the integration of these mobility mechanisms.

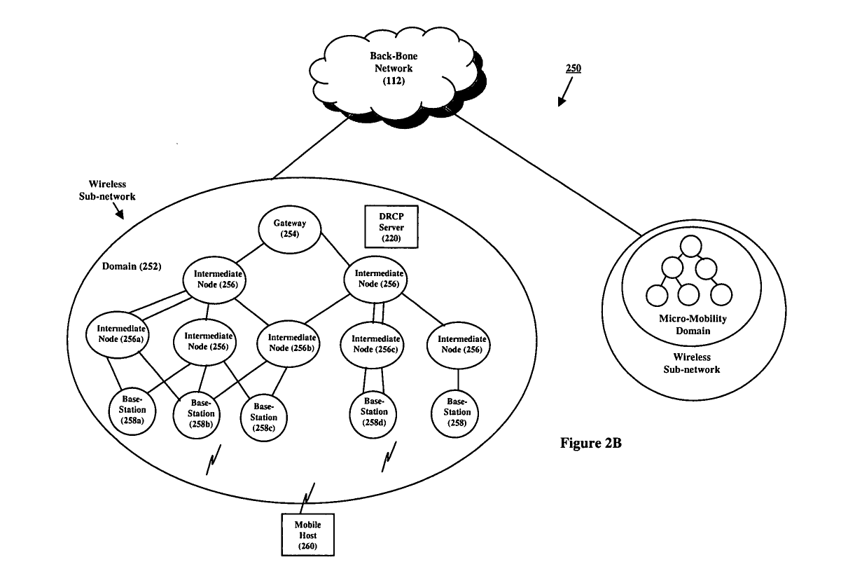

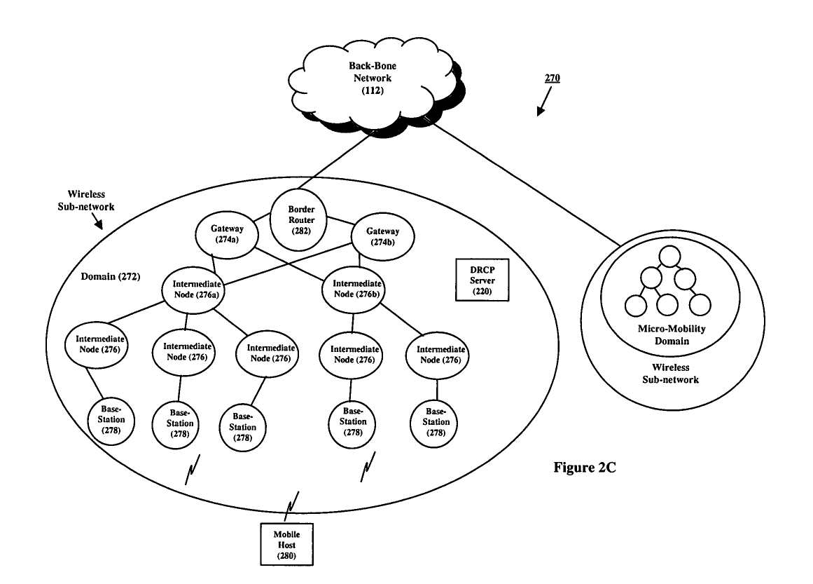

FIG. 2A shows a first exemplary network architecture 200 for micro-mobility management using MMP. The following will first describe MMP from the network perspective and then from the mobile host perspective. Under MMP, each sub-network 204 and 204 is divided into one or more domains 206, 208, and 210 and includes a DHCP server (dynamic host configuration protocol) or preferably, a DRCP (dynamic registration and configuration protocol) server 220. Each domain is a network of nodes 212-216 configured as an inverse tree structure. The bottom nodes of the network are base stations 216 with wireless interfaces 218 that provide mobile hosts 222 access to the network 200. The intermediate nodes 214, which can also be referred to as MMP nodes, comprise routers and layer-2 switches. The top node of the network is a gateway 212 that acts as the interface between the micro-mobility domain 206, 208, or 210 and the rest of the network. When a sub-network comprises multiple domains, such as sub-network 202, a border router 224 interconnects the domains 206-208 (i.e., gateways 212a-b) and interfaces these domains to the rest of the network. Within a domain, each base station 216 and intermediate node 214 has a single interface to a node above it towards the gateway 212. Similarly, the gateway 212 and intermediate nodes 214 have one or more down-stream interfaces towards the base stations 216.

As indicated, each sub-network also includes a DRCP server 220, which provides a mobile host 222 with a new care-of-address when it moves into the sub-network. The DRCP server can be a standalone system within a sub-network or reside at existing network nodes, such as the gateway 212 or an intermediate node 214. (Note also that the DRCP server could reside at both the gateway and intermediate nodes. Here, the DRCP server at the gateway configures the interfaces of the intermediate nodes, and one of the DRCP servers that is resident at the intermediate nodes configures the wireless interfaces of the base stations and configures the mobile nodes.) In general and as is known in the art, a DRCP server periodically broadcasts an “advertisement” message throughout a sub-network towards the mobile hosts. A mobile host entering the sub-network and needing a new IP address responds to the “advertisement” message by negotiating with the DRCP server for an address, which in the context of our invention is the care-of-address. As indicated, a care-of-address does not change while a mobile host moves within a domain or between domains of the same sub-network, such as between domains 206 and 208. It only changes when a mobile host moves between sub-networks, such as between sub-networks 202 and 204. As such and as further described below, the care-of-address is primarily used for routing packets to and from the sub-network in which the mobile host is currently located. MMP handles the actual routing within a domain/sub-network.

Specifically, rather than using a routing protocol such as RIP (Routing Information Protocol) or OSPF (Open Shortest Path First) to perform routing within a domain, each domain uses host-based routing. Under host-based routing, the domain nodes self-configure to determine a path from the gateway 212 towards a mobile host 222 and from a mobile host 222 towards the gateway 212. Specifically, the gateway 212 periodically broadcasts a “gateway-beacon” message on each of its down-stream interfaces towards the intermediate nodes 214. The gateway-beacon includes the gateway's IP address and an optional domain ID (Note that within a given domain, some of the base stations could provide paging cache support. In this case, the gateway-beacon message also includes a paging ID.). Each intermediate node 214 receiving the gateway-beacon records the interface (and possibly the source MAC address of the beacon message) through which the beacon came and notes this interface as the next-hop, up-link interface for reaching the gateway 212. Each intermediate node 214 then re-broadcasts the gateway-beacon on its remaining interfaces towards other intermediate nodes, where the process is repeated until the base stations 216 receive the beacon and the process stops. Once the process is complete, each domain node has a next-hop, up-link interface for reaching the gateway 212 and as such, the domain comprises a set of up-link routes from each base station 216 towards the gateway 212. Accordingly, each time a mobile host 222 within a domain transmits a packet, the receiving base station 216 routes it onto its next hop, up-link interface towards an intermediate node 214, which again routes the packet on its up-link interface until the gateway 216 is reached. The gateway then forwards the packet onto the network 112. The gateway periodically broadcasts the “gateway-beacon” message to ensure the up-stream routes stay current in case, for example, the domain is reconfigured.

For downlink routing from the gateway 212 to a mobile host 222, each base station 216, each intermediate node 214, and the gateway 212 maintain a routing cache. Each cache entry at a given node comprises a mobile host's care-of-address (i.e., the care-of-address assigned to the mobile host when it entered the domain) and a downlink interface towards a base station that can be used to reach the mobile host. Specifically, each time a mobile host enters a domain and receives a new care-of-address from the DRCP server 220, the mobile host sends a “registration” message to its receiving base station 216. The “registration” message is addressed using the gateway's IP address as the destination address and the mobile host's care-of-address as the originating address. The base station 216 and intermediate nodes 214 route this message towards the gateway 212 using the up-link routes described above. However, prior to forwarding a packet on an up-link interface, each node first analyzes the originating IP address (i.e., care-of-address) and records this address in its routing cache along with the down-link interface from which the message came, thereby recording this interface as the next-hop, down-link interface when routing packets from the gateway 212 towards the mobile host 222. Once this process is complete, the domain comprises a set of downlink routes from the gateway 212 to each base station 216. Accordingly, each time a packet is routed from the network 112 to a sub-network 202-204/gateway 212, the gateway 212 routes the message based on its routing cache entry onto a next-hop, down-link interface towards an intermediate node 214, which repeats the process until a base station 216 is reached. The base station then forwards the packet to the mobile host over the wireless interface 218. (Note that when a gateway 212a/b interfaces a border router 224, the border router 224 and gateways use OSPF or RIP, for example, to configure the border router to properly route packets from the network 112 to the proper gateway, thereby ensuring proper routing within the sub-network.)

Accordingly, while within a domain, all packets a mobile host 222 transmits are addressed using the care-of-address as the originating address and are routed through the domain to the gateway 212 using MMP. The gateway 212 then passes the packet onto the network 112 where traditional routing mechanisms are used based on the care-of-address. Similarly, all packets transmitted to a mobile host 222 are addressed to the care-of-address and are routed though the network 112 to a sub-network/gateway using traditional routing mechanisms. The gateway then routes the packet through its domain using MMP.

It should be further noted that the routing caches at each node within a domain are self-maintaining. In particular, the routing cache entries use a soft state and as such, a node automatically clears a cache entry when not referenced after a period of time. The advantage of this configuration is that the routing caches do not need to be updated once a mobile host leaves a domain. However, while a mobile host remains in the domain, the routing cache entries must be periodically refreshed. Accordingly, each time a mobile host transmits a packet, each node along the up-link path refreshes its routing cache entry as it forwards the packet towards the gateway. Because a mobile host may not transmit packets for a prolonged period of time, the mobile host will periodically force a refresh by transmitting a “route update” message to the gateway.

A mobile host may also move within a domain between base stations, such as mobile host 222b moving from base stations 216b to base station 216a of domain 210. When this occurs, the current downlink routing path from gateway 212c, through intermediate node 214a, and base-station 216b to mobile host 222b becomes invalid. When this occurs, base station 216a, intermediate node 214b, and intermediate node 214a (referred to as the cross over node in this case because it is the common node in the up-link route between base station 216a and gateway 212c and between base station 216b and gateway 212c) must initialize/update their routing caches. The mobile host forces this update when it moves between base stations by transmitting a “cache update” message to gateway 212c. Under MMP, this can occur as either a hard handoff or a semi-soft handoff.

When hard handoff is used, the mobile host 222b transmits a “hard handoff cache update” message to base station 216a towards gateway 212c. Because the base station 216a and intermediate node 214b are unfamiliar with the mobile host, they treat this message like a “registration” message, recognizing the new care-of-address and adding a new entry to their routing caches. When the crossover node 214a receives the message, it updates its routing cache entry for the care-of-address, replacing the original downlink interface 228 with the new interface 226 pointing towards base station 216a. At this point, the handoff is complete, and the route cache entries at the nodes along the original up-link path between the crossover node 214a and base station 216b are left to expire when they time-out (here, the entry in the routing cache at the base station 216b will be left to expire). Note however, that once the mobile host 222b transmits the “cache update” message to base station 216a, it is no longer listening to base station 216b. Hence, any packet(s) that had been sent to base station 216b from the crossover node 214a prior to receiving the “cache update” message are never received by the mobile host and are lost.

To address this packet loss issue, semi-soft handoff can be used. Here, when the mobile host moves to base station 216a, it transmits a “semi-soft handoff cache update” message towards the gateway. However, rather than do a hard handoff and continuing to listen to base station 216a as above, the mobile host switches back to listening to base station 216b for a short period, referred to as the “semi-soft period,” while waiting for the “semi-soft handoff cache update” message to reach the crossover node 214a. Furthermore, the crossover node 214a, upon receiving the cache update message, adds a second entry in its in the routing cache (i.e., an additional entry) for the mobile host's care-of-address, rather than updating the original entry as above (hence, there is an entry for interface 226 and for interface 228 with respect to the mobile host's care-of-address). Because the crossover node now has two entries for the mobile host, it sends any packets it receives for the mobile host to base station 216a and to base station 216b. This process ensures the mobile host does not lose any packets. At the end of the semi-soft period, the mobile host switches back to listening to base station 216a and sends a “hard handoff cache update” message, causing the crossover node to remove the original care-of-address entry pointing to base station 216b and completing the handoff.

As described above, each base station 216 and each intermediate node 214 has only a single interface to the node above it towards the gateway 212. Accordingly, only a single route/path exists between a given base station and the gateway, making the MMP architecture susceptible to node and link failures. FIG. 2B shows a second exemplary MMP architecture 250 wherein each base station 258 and intermediate node 256 within a given domain 252 can have one or more interfaces to the nodes above it (see, for example, intermediate nodes 256a-c and base stations 258a-d), allowing for the creation of primary and secondary paths between a given base station 258 and the gateway 254. In this second embodiment of the MMP architecture, the gateway 254 continues to periodically broadcast a “gateway-beacon” message on each of its downlink interfaces. This message comprises the gateway's IP address and an optional domain ID, as above. The message also includes a sequence number, which the gateway increments on each broadcast, and a timestamp, which indicates when the gateway issued the beacon. Unlike the first embodiment described above, each intermediate node 256 now receives a given gateway-beacon message on possibly one or more interfaces. Accordingly, the intermediate node records each interface through which a gateway-beacon message comes as a possible next-hop, up-stream interface for reaching the gateway 254. However, the intermediate node also classifies each interface as either a primary interface or a secondary interface for reaching the gateway, thereby creating a primary path and one or more secondary paths for reaching the gateway. The choice of which interface is the primary interface and which interface is the secondary interface can be based on various criteria. For example, using the timestamp in a given beacon message an the node's internal clock, the node can determine which of its up-link interfaces experience a longer delay in receiving beacon messages and can thereby classify the interfaces based on latency. As another example, the node can classify the interfaces based on reliability. Here, not all beacon messages may arrive at a given interface, as detected by a gap in the sequence numbers. When this occurs, the node can classify the interface as unreliable and therefore as a secondary interface. In order to ensure that a given gateway-beacon message has arrived at each of its interfaces, a node will wait for a short random delay prior to classifying the interfaces.

Once classifying the interfaces, the intermediate node 214 then re-broadcasts one of the received gateway-beacon messages on its remaining interfaces towards the other intermediate nodes, where the process is repeated until the base stations 216 receive the beacon(s) and the process stops. Note that once a node forwards a gateway-beacon, it disregards any future beacons where the sequence number is lower than or equal to the sequence number of one of the previously received gateway-beacons.

Once this process is complete, each domain node has a primary next-hop, up-link interface for reaching the gateway 254 and possibly one or more secondary next-hop, up-link interfaces. As such, the domain comprises a set of primary up-link routes and secondary up-link routes from each base station 258 towards the gateway 254. In general, each time a mobile host 260 within the domain 252 transmits a packet, the receiving base station 258 routes it onto its primary next hop, up-link interface towards an intermediate node 256, which again uses its primary interface, until the gateway 254 is reached. However, if a node or link failure occurs, a given node will automatically switch to a secondary interface and therefore a secondary path.

More specifically, when a node or link failure occurs, a given base station 258 or intermediate node 256 may automatically reclassify a given interface from secondary to primary, as the node no longer receives gateway-beacon messages over the interface. Similarly, a node may switch to a secondary interface if it detects a failure in its primary interface. While this switch automatically resolves the up-link routes to the gateway, it may also invalidate the routing cache entries that define the downlink routes from the gateway to a mobile host. However, as discussed above, the routing caches are self-maintaining. Each time a mobile host transmits a packet, each node along the up-link path automatically refreshes its routing cache entry as it forwards the packet towards the gateway. Accordingly, if a secondary path is used and a node is reached where the routing cache has no entry for a given mobile host, a new entry is created and the MMP domain is automatically healed with respect to the downlink routing.

While the use of additional interfaces between the nodes addresses node and link failures, the use of a single gateway is still a point of failure in the MMP architecture. FIG. 2C shows a third exemplary MMP architecture 270 wherein a given domain 272 comprises two or more gateways 274a and 274b and wherein one or more intermediate nodes 276 (or base stations 278) of the domain are interfaced to each gateway (see, for example, intermediate nodes 276a and 276b), thereby creating a primary gateway and a secondary gateway.

Here, each intermediate node 276 (or base station 278) initially starts with no default gateway. Similar to above, each gateway periodically broadcasts on each of its downlink interfaces a gateway-beacon message wherein the message comprises the gateway's IP address, an optional domain ID, a sequence number (which each gateway increments on each broadcast), and a timestamp (which indicates when the gateway issued the beacon). As an intermediate node 274a or 274b receives the beacon message, it determines which gateway sent the message, as determined by examining the IP address field. If the node is not aware of the gateway, it records an entry for the gateway. Regardless, the node records the interface on which the beacon was received as the up-link interface for reaching the gateway, records the sequence number of the message, and records an estimate of the distance to this gateway based on the timestamp information and the node's internal clock. (Note that if the sequence number of the received beacon is lower than or equal to the sequence number of one of the previously received gateway beacons from the same gateway, the beacon message is disregarded). Next, the node classifies (or re-classifies) the gateway as either a primary gateway or a secondary gateway (and accordingly, classifies its interfaces as an up-link interface for reaching the primary gateway or secondary gateway). This determination can be based on various criteria such as latency to the gateway (using the estimated distance to the node) or reliability (as detected by a gap in sequence numbers). In order to ensure that a gateway-beacon message has arrived from each gateway, a node will wait for a short random delay prior to classifying the gateways.

Once classifying the gateways, the intermediate node 274a or 274b then re-broadcasts onto each of its remaining interfaces towards the other intermediate nodes the gateway-beacon message from the gateway classified as the primary gateway. Accordingly, as shown in FIG. 2C where each base station 278 and each intermediate node 276 (other than nodes 276a and 276b) has only one uplink interface, the nodes continue to broadcast the gateway-beacon message as described above with reference to FIG. 2A, each time noting the up-link interface. As such, only intermediate nodes 276a and 276b are aware there are multiple gateways. However, if the remaining base stations 278 and intermediate nodes 276 have multiple up-link interfaces as shown in FIG. 2B, these base stations/intermediate nodes may receive gateway-beacon messages from both gateways 274a and 274b. Accordingly, these base stations/intermediate nodes will also classify the gateways, noting the interface(s) for reaching the primary gateway and secondary gateway. Again, each node will only re-broadcast the gateway beacon message corresponding to the gateway it classified as the primary gateway.

Once this process is complete, the domain consists of routes from the base stations to the primary gateway and routes from the base stations to the secondary gateway. Using FIG. 2C as an example, there is a single up-link route from each base station 278 through the intermediate nodes 276 to the intermediate nodes 276a and 276b. At this point, the intermediate nodes recognize multiple gateways, thereby creating a path to a primary gateway and a path to a secondary gateway. Combining the concepts of FIGS. 2B and 2C where the domain comprises multiple gateways and multiple paths between the intermediate nodes and base stations, the domain would consist of primary and secondary paths to a primary gateway and consist of primary and secondary paths to the secondary gateways.

Continuing with FIG. 2C as an example, as a mobile host 280 transmits packets, these packets are routed through the up-link routes to the intermediate nodes 274a or 274b. When the intermediate nodes receive the packets, it in turn routes them to the gateway 274a or 274b it has classified as the primary gateway. However, if the intermediate node detects a failure in the primary gateway (e.g., by detecting an interface failure by failing to receive gateway-beacon messages), it switches to the secondary gateway. (Note that based on OSPF or RIP routing mechanisms between border route 282 and the gateways 274a and 274b, the border router automatically updates its routing tables when a change from the primary to the secondary gateways occurs, thereby ensuring a proper routing of packets from the network 112 to domain 272 and the mobile host 280.)

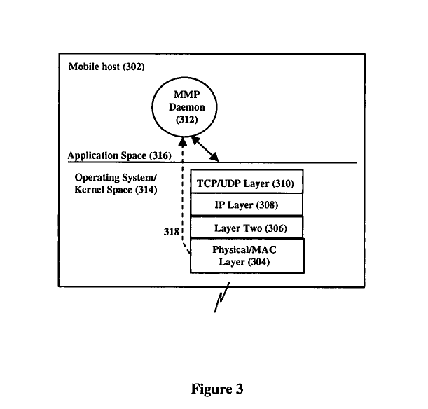

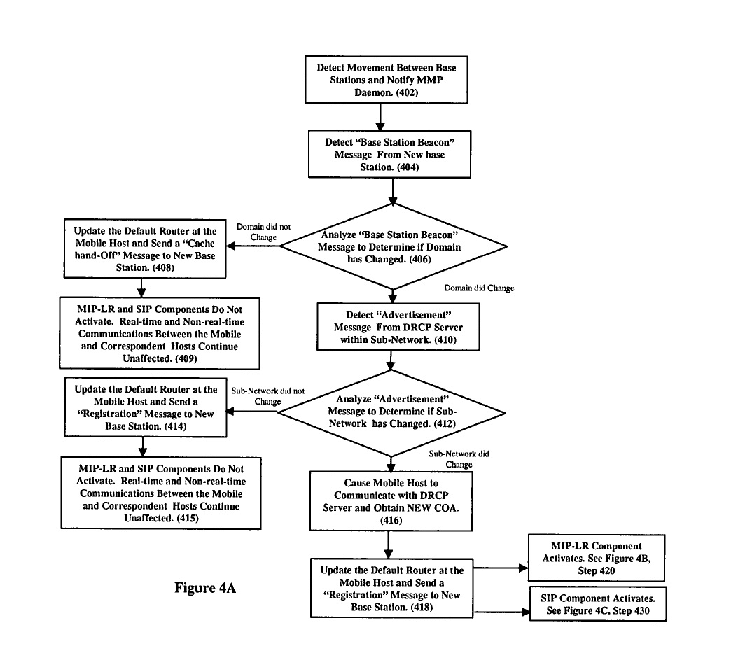

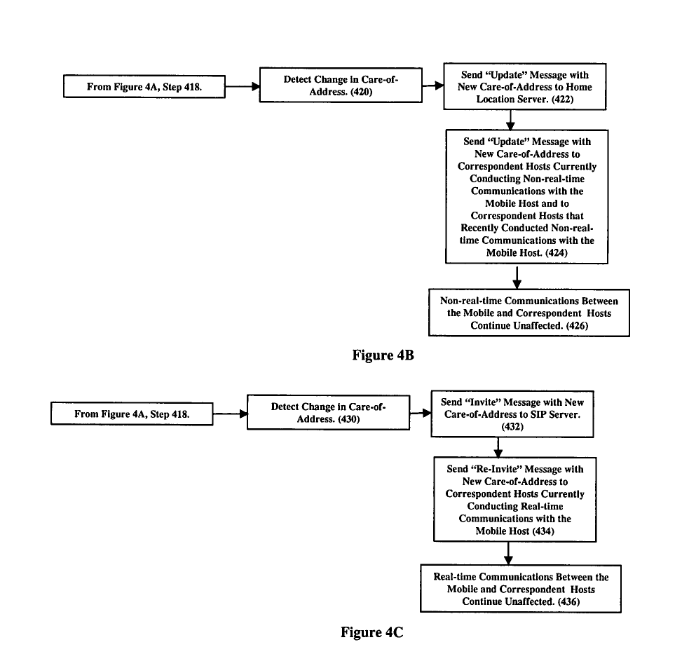

Reference will now be made to MMP from the mobile host perspective and in particular, describe the actual movement of a mobile host both within and between domains (Note that the discussion assumes a MMP architecture as shown in FIGS. 2A and 2B, but is essentially the same if secondary gateways are used since the gateways are within the same sub-network). FIG. 3 shows an exemplary architecture of the mobile host 302, showing the MMP components of our invention (note that subsequent Figures will show the integrated MIP-LR and SIP components). The mobile host comprises a wireless physical interface 304 and IP communications protocol stack (layer two 306, IP layer 308, and TCP/UDP layer 310), as in known in the art. In accordance with our invention, a mobile host also comprises an MMP daemon process 312 that can execute in either kernel space of the mobile host operating system 314 or preferably, within application space 316. As indicated, a mobile host can make three types of mobility movements, inter-domain movements between domains of different sub-networks, inter-domain movements between domains of the same sub-network, and intra-domain movements. Through interactions with the base stations and DRCP server, the MMP daemon 312 executes the process as shown in FIG. 4A and determines the type of movements the mobile host makes and correspondingly interacts with the MMP domain to update the MMP routing and to obtain a new care-of-address.

Specifically, as shown in step 402, each time a mobile host moves between base stations, the physical interface 304 detects the movement (e.g., change in channel) and notifies the MMP daemon 312 (as shown by notification 318), signaling to the daemon that a macro or micro movement has taken place. In response, the MMP daemon in step 404 looks for a broadcast beacon from the new base station. More specifically, each base station within a domain periodically broadcasts a “base station-beacon” message onto its wireless interface. This beacon message includes the base station ID, layer 2 parameters related to the base station, the IP address of the domain gateway, and optionally, the domain ID (again, it may also include a paging ID if he domain provides paging cache support). The base station obtains the gateway IP address and domain ID from the “gateway-beacon” the gateway periodically broadcasts.

Upon receiving the “base station beacon” message, the MMP daemon in step 406 compares the domain ID (if present) or gateway IP address to a domain ID/gateway IP address obtained from a prior beacon message and determines if the mobile host has changed domains. If the domain did not change, the MMP daemon proceeds to step 408 and forces an update of the mobile host's default router to be the new base station and sends a “cache hand-off” message (i.e., either hard hand-off or semi-soft handoff cache update message) to the new base station and with the message addressed to the gateway, this message thereby causing a route update within the MMP domain as described above. Note that as further described below, this type of movement does not cause the MIP-LR and SIP components of our invention to activate. In addition, any real-time (i.e., RTP/UDP) communications and non-real-time (i.e., TCP) communications occurring between the mobile and correspondent hosts continue to operate, unaffected by the movement (as shown by block 415).

If the domain did change, the MMP daemon proceeds to step 410 and looks for the broadcast “advertisement” message from the DRCP server within the sub-network. In particular, because the MMP daemon at this point has determined that the mobile host has moved between domains, it needs to further determine if the mobile host moved between domains within the same sub-network or between domains of different sub-networks. Based on the “advertisement” message, the MMP daemon in step 412 compares the currently configured subnet of the mobile host to the subnet as specified by the DRCP server. If the subnets did not change, the mobile host has not changed sub-networks and therefore does not need to update its care-of-address. The mobile host only needs to register with the new MMP domain. Accordingly, the MMP daemon proceeds to step 414 and forces an update of the mobile host's default router to the new base station and sends a “registration” message addressed to the gateway towards this base station. This message is addressed using the mobile host's current care-of-address as the origination address and causes the nodes of the new domain to establish a new up-link route to the gateway. Again, this type of movement does not cause the MIP-LR and SIP components of our invention to activate and does not affect any RTP/UDP and TCP communications occurring between the mobile and correspondent hosts (as shown by block 415).

If, however, the sub-network did change, the mobile host needs to update its care-of-address. Accordingly, the MMP daemon proceeds to step 416 and forces the mobile host to negotiate with the DRCP server, as is known in the art, to obtain a new care-of-address and to reconfigure the mobile host's interface. After forcing an update of the mobile host's default router to the new base station, the MMP daemon sends a “registration” message to the new base station. This message is now addressed using the new care-of-address as the origination address and causes the nodes of the new domain to establish a new up-link route to the gateway. As the gateway receives the “registration” message, it responds to the mobile host with an “acknowledgement” message, signifying that the registration is complete. Note that as further described below, this type of movement does affect RTP/UDP and TCP communications occurring between the mobile and correspondent hosts because the care-of-address has changed. Accordingly, the MIP-LR and SIP components active to ensure these communications continue to operate unaffected by the movement.

Note further that as discussed above, the routing cache entries of the nodes comprising a MMP domain use a soft state and must be periodically refreshed. Accordingly, the MMP daemon also monitors a mobile host's packet transmissions and if no packets are transmitted for a prolonged period of time, it forces a refresh by transmitting the “route update” message to the gateway.

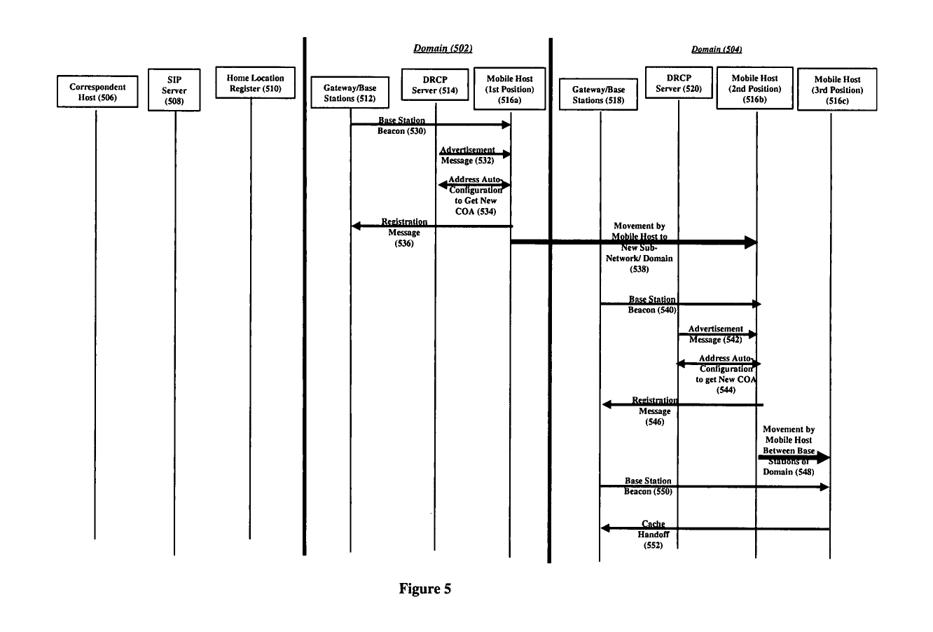

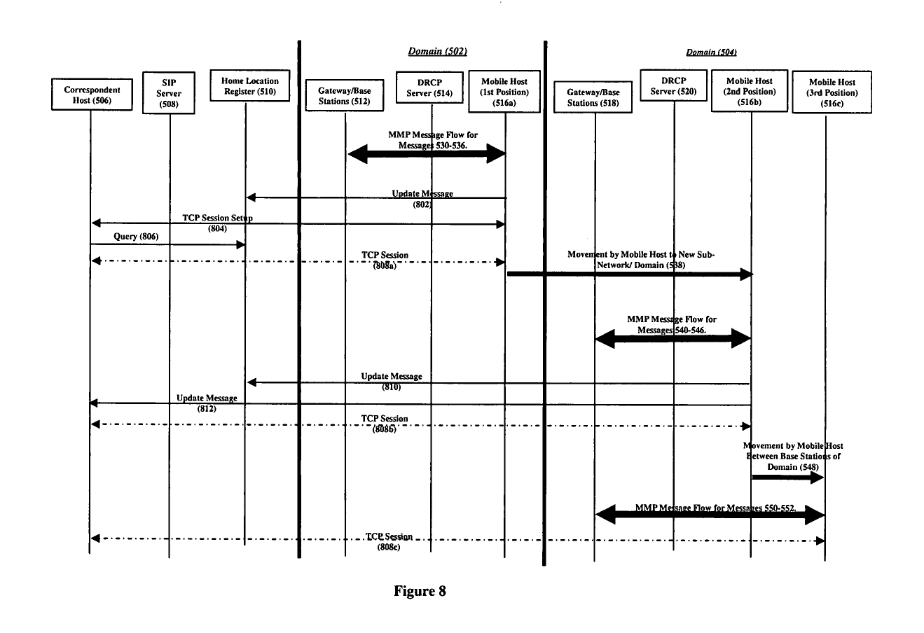

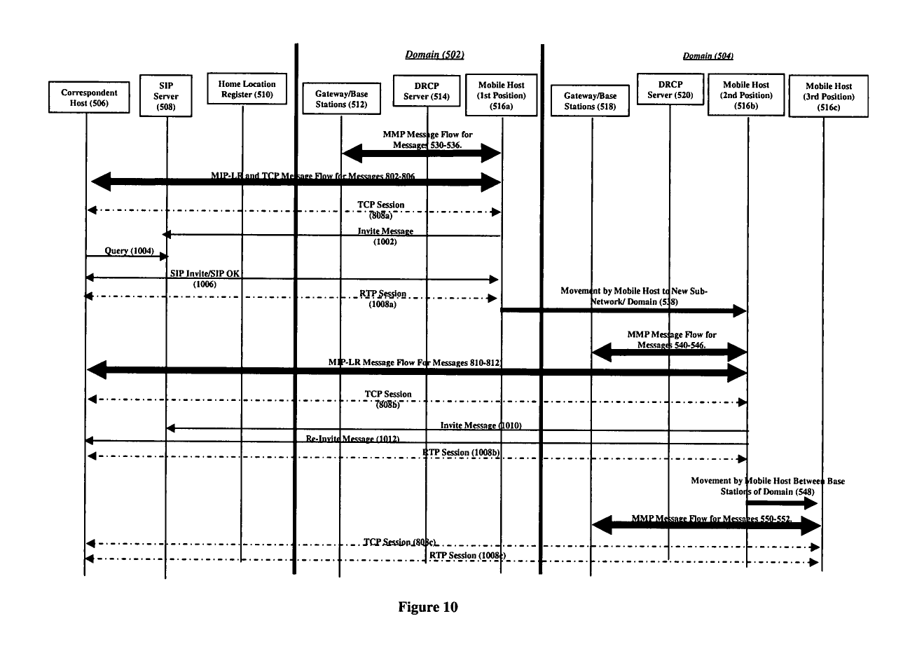

FIG. 5 shows an exemplary message flow that occurs while the mobile host moves between and within two domains, domain 502 and domain 504, that are located in different sub-networks (note that this Figure contains elements further expanded on below in FIGS. 8 and 10 in relation to the MIP-LR and SIP discussions). Note that for space purposes, intermediate MMP nodes are not shown and the gateway/base stations 512 within domain 502 and the gateway/base stations 518 within domain 504 are shown as a single entity. Assuming the mobile host 516a first enters domain 502 from a different sub-network, the MMP daemon at the mobile host receives the “base-station beacon” message 530 from base station 512 and receives the “advertisement” message 532 from DRCP server 514, indicating that it is in a new sub-network/domain. As a result, the MMP daemon communicates with the DRCP server to obtain a new care-of-address (COA) (as shown by address auto-configuration 534) and then sends “registration” message 536 to gateway/base station 512 to create an up-link route within domain 502.

Assuming the mobile host 516a then moves (as shown by line 538) to a new sub-network and domain 504 (the mobile host now being shown as 516b), the MMP daemon at the mobile host receives a “base-station beacon” message 540 from base station 516 and receives an “advertisement” message 542 from DRCP server 520, thereby indicating the new domain. Again, the MMP daemon at the mobile host communicates (messages 544) with the DRCP server to get a new care-of-address and registers (message 546) this care-of-address with the gateway 518. Finally, assuming the mobile host moves between base stations within domain 504 (shown by line 548), the MMP daemon receives the “base-station beacon” message 550 from the base station and realizing it has not changed domains, sends a “cache hand-off” message 552 to gateway 518 to update the up-link route in domain 504.

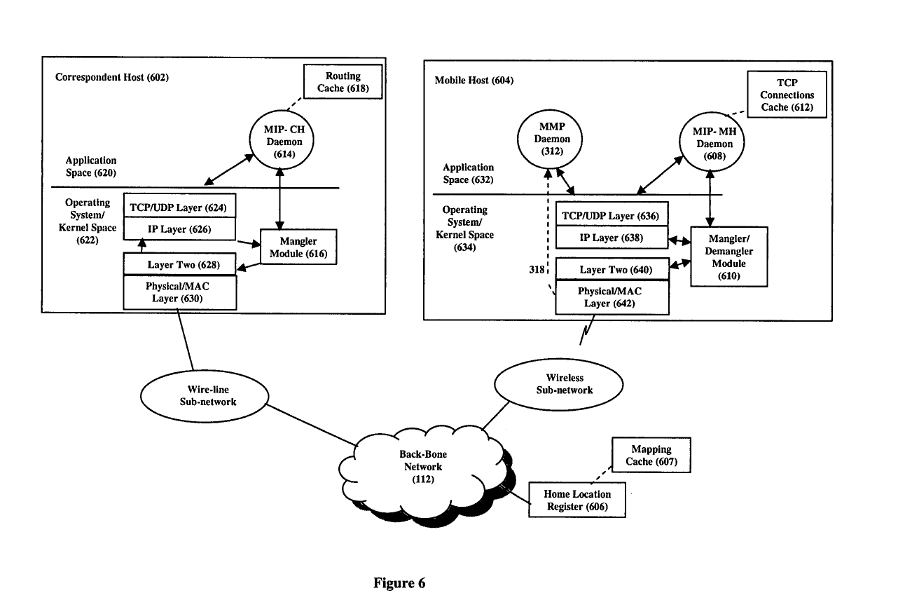

Reference will now be made to the MIP-LR component of our invention. As indicated, MIP-LR manages the connection-oriented communications between the mobile host and correspondent host for non-real-time applications. FIG. 6 shows the MIP-LR system of our invention, which comprises one or more home location registers 606, a MIP-MH daemon 608 and mangler-demangler module 610 at each mobile host 604, and a MIP-CH daemon 614 and a mangler module 616 at each correspondent host 602. The MIP-MH daemon further comprises a TCP connections cache 612 and the MIP-CH daemon further comprises a routing cache 618. Note again that the following assumes the correspondent host 602 is stationary.

As mentioned above, from the perspective of a connection-oriented application at the correspondent host, the mobile host is addressed using the mobile host's permanent IP address. Hence, from the application's perspective, all packets transmitted to the mobile host and received from the mobile host have the mobile host's permanent IP address in the destination or origination field of the IP packet, respectively. (Note that when the correspondent host originates communications, it can obtain the mobile host's permanent IP address using traditional mechanisms such as DNS (domain name system).) Similarly, from the perspective of a connection-oriented application at the mobile host, connections to the correspondent host are through the mobile host's permanent IP address. However, the actual routing of packets between the mobile and correspondent hosts occurs through the mobile host's current care-of-address. The mapping between the permanent IP address and care-of-address and the updating of the care-of-address during mobility from the application perspective occurs through the MIP-LR system.

Beginning with the home location register 606, it is a server that maintains a mapping cache 607 that provides a mapping between a mobile host's permanent IP address and its current care-of-address. Each mobile host is responsible for maintaining the home location register's mapping cache. Specifically, the MIP-MH daemon 608 at each mobile host 604 periodically monitors the mobile host interface to determine the currently configured IP address. When this address changes (due to the MMP daemon 312 forcing an update of the address due to a change in sub-networks), the MIP-MH daemon sends an “update” message to the home location register 606, specifying an update. The home location register responds to the “update” message with a “registration lifetime.” Prior to the expiration of this lifetime, the MIP-MH daemon must refresh the home location register with a new “update” message or the home location register will remove the entry. In general, when an application at a correspondent host 602 needs to establish a connection to an application at the mobile host 604, the correspondent host sends a query to the home location register specifying the mobile host's permanent IP address. The home location register in turn provides the mobile host's current care-of-address and the remaining “registration lifetime.”

The MIP-LR system requires only a single home location register. However, for redundancy purposes, the system preferably includes more than one home location register. In this case, the MIP-MH daemon needs to send a “registration” message to every home location register when it's care-of-address changes. A mobile host can be pre-configured with a list of the home location registers or can obtain the list using the DNS “SRV” mechanism, for example. Similarly, each correspondent host will need to be configured with a preferred set of home location registers.

Reference will now be made to the MIP-CH daemon 614 and mangler module 616 and to the MIP-MH daemon 608 and mangler-demangler module 610 assuming no mobility is taking place. The MIP-CH daemon 614 initializes when the correspondent host 602 first boots-up. This daemon can execute in kernel space within the operating system 622 or preferably, in application space 620. Upon initializing, the daemon determines an appropriate home location register and then configures the mangler module 616.

The mangler module 616 is essentially a capture filter that resides within the communications stack of the correspondent host's operating system beneath the TCP/UP layer 624 and IP layer 625 and above layer two 628 and the physical layer 630 of the stack. The MIP-CH daemon 614 configures the mangler 616 to analyze all packets transmitted by the correspondent host 602 as these packets leave the IP layer 626 and to capture the TCP packets and pass them to the daemon. Note that packets related to real-time communications pass through the filter and go directly to layer two 628. Note that in addition to TCP packets destined for mobile hosts, the mangler will also capture TCP packets for any connection-oriented communications the correspondent host maintains with other non-mobile hosts. These packets do not need to pass through the MIP-LR system. Accordingly, the MIP-CH daemon could further refine the mangler to capture only TCP traffic related to mobile hosts. If the permanent IP addresses assigned to mobile hosts are confined to well-defined address spaces, such a functionality, for example, could be done by further configuring the mangler to also filter on IP addresses.

As the daemon 614 receives a TCP packet from the mangler 616, it determines if the packet is destined for a mobile host (as described below). If the packet is destined for a mobile host, the daemon changes the destination address of the packet from the mobile host's permanent IP address to its current care-of-address. The daemon then passes the modified packet back to the mangler 616 where it is transmitted to layer two 628 and transmitted to the network. For TCP packets not destined for a mobile host, the daemon leaves the packet unmodified and returns the packet to the mangler for transmission. Note that all packets received from the network pass directly from layer two 628 to the IP layer 626, bypassing the mangler 616 and daemon 614. The mangler 616 can be implemented, for example, using the Linux “libipq” and “iptables” library or can be implemented through modifications of the operating system kernel, etc.

Accordingly, as an application at the correspondent host transmits a TCP packet; the mangler module 616 intercepts the packet and passes it to the MIP-CH daemon 614. The daemon maintains the routing cache 618, which is a local mapping of mobile hosts' permanent IP addresses to care-of-addresses. If the destination address specified in the intercepted packet is not in the cache 618, the MIP-CH daemon sends a query to home location register 606, asking for a current mapping of the destination address specified in the packet to a care-of-address. Assuming the specified address corresponds to a mobile host, the home location register returns to the MIP-CH daemon 614 the mobile host's current care-of-address along with the remaining registration lifetime for this address. The daemon 614 places the address and registration lifetime in its routing cache 618, modifies the destination address of the TCP packet with the care-of-address, and then passes the packet back to the mangler module 616 for transmission. When an application at the correspondent host subsequently transmits a TCP packet to the mobile host, the mangler 616 again captures the packet and passes it to the MIP-CH daemon 614. However, rather than query the home location register 606, the daemon now accesses the routing cache for the mapping assuming the registration lifetime has not expired. If the lifetime has expired, the daemon 614 will again access the home location register. This process ensures the routing cache 618 does not become stale.

Assuming the mangler module 616 is not configured to discern between TCP packets destined for mobile and non-mobile hosts, the MIP-CH daemon 614 will also receive TCP packets destined for non-mobile hosts and that therefore do not need to be modified. Because the MIP-CH daemon also cannot discern between mobile and non-mobile traffic, it will again query the home location register 606 looking for a mapping between a permanent IP address and a care-of-address. Here, the home location register will specify that no mapping is present, causing the MIP-CH daemon to enter a null mapping in its local routing cache 618 and to leave these packets (and future packets) unmodified.

Note further that the MIP-CH daemon 614 and mangler module 616 are not used for traffic coming from the mobile host (or non-mobile hosts). This is because the MIP-MH daemon 608 and mangler-demangler module 610 ensure all transmitted packets are marked with the permanent EP address in the origination field, as described below.

Turning to the MIP-MH daemon 608 and mangler-demangler module 610, the daemon initializes when the mobile host 604 first boots-up and can execute in kernel space within the operating system 634 or preferably, in application space 632. Upon initializing, the daemon configures the mangler-demangler module 610, which like the mangler module 616, is essentially a filter that resides within the communications stack of the mobile host's operating system beneath the TCP/UDP layer 636 and IP layer 638 and above layer two 640 and the physical layer 642. More specifically, the MIP-MH daemon 608 configures the mangler-demangler module 610 to capture all TCP packets received by the mobile host as these packets leave layer two 640 and to capture all TCP packets transmitted by the mobile host as these packets leave the IP layer 638. The mangler-demangler module 610 then passes all captured TCP packets to the daemon 608 for modification. Note that packets related to real-time communications (whether transmitted or received) pass through the mangler-demangler and are unaffected by the MIP-LR system.

As indicated, from the perspective of a connection-oriented application at the mobile host, connections to the mobile host are through the mobile host's permanent IP address. However, as just described, as a packet leaves a correspondent host the destination field is set to the mobile host's care-of-address for routing purposes. Accordingly, as the packet enters the mobile host's communication stack, the mangler-demangler module 610 captures the packet prior to entering the IP layer 638 and passes the packet to the MIP-MH daemon 608, which replaces the care-of-address in the destination field with the mobile host's permanent IP address. The daemon then passes the packet back to the mangler-demangler module 610 where the packet is returned to the IP layer 638 and eventually passed to a mobile host application. Similarly, as discussed a correspondent host expects TCP packets from a mobile host to have the origination field set to the mobile host's permanent IP address. However, because the mobile host interface is configured with the care-of-address, the IP layer 638 marks the origination field of packets transmitted by a mobile host with the care-of-address. Accordingly, the mangler-demangler module 610 captures all TCP packets the mobile host transmits as the packets exit the IP layer 638 and passes these packets to the MIP-MH daemon 608, which replaces the care-of-address with the permanent IP address and passes the packet back to the mangler-demangler module 610 where the packet is returned to the layer two 640 and transmitted. As such, when the packet arrives at the correspondent host, it is appropriately marked, as discussed above.

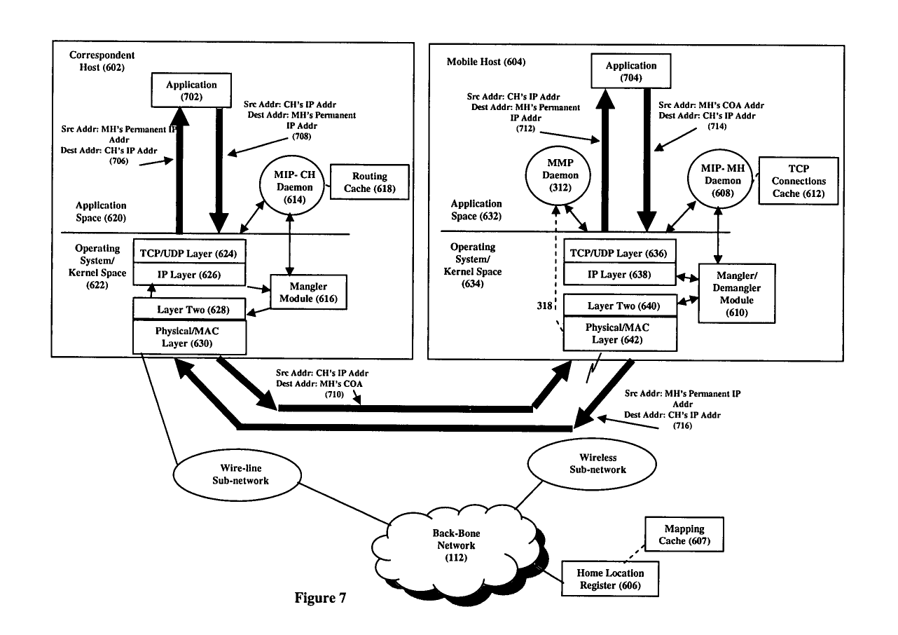

FIG. 7 is an exemplary communication between a correspondent host application 702 and a mobile host application 704, showing how the MIP-LR system modifies the IP addresses of transmitted/received packets. As shown, as application 702 transmits packets 708, the source IP address field is set to the correspondent host and the destination IP address field is set to the mobile host's permanent IP address. As these packets leave the correspondent host, the MIP-CH daemon 614 and mangler module 616 set the destination field of the packets 710 to the mobile host's care-of-address for routing purposes. As these packets pass through the MIP-MH daemon 608 and mangler-demangler 610 of the mobile host, the destination field of the packets 712 is now set to the mobile host's permanent IP address for application 704. Similarly, as an application 704 transmits packets 714, the mobile host sets the source IP address field to the mobile host's care-of-address. As these packets leave the mobile host, the MIP-MH daemon 608 and mangler-demangler module 610 changes the source IP address to the mobile host's permanent IP address. As these packets 706 pass through the communications stack of the correspondent host, they remain unchanged by the MIP-CH daemon 614 and mangler module 616.

Reference will now be made to how the MIP-LR system allows connection-oriented applications at the correspondent host and mobile host to maintain a connection while the mobile host moves and changes its care-of-address, which process is shown in FIG. 4B. Again, the importance of applications using the mobile host's permanent IP address while the MIP-LR system converts the communications to using the care-of-address is that the care-of-address is independent from the applications and can thereby change without affecting an on-going connection.

As described above, when the mobile host moves and updates its care-of-address through MMP (steps 416-418 of FIG. 4A), the MIP-MH daemon 608 detects the change (step 420 of FIG. 4B) and sends an “update” message with the new care-of-address to home location register 606, allowing new correspondent hosts to find the mobile host (step 422). However, the MIP-MH daemon must also send the change in address to correspondent hosts that have recently conducted connection-oriented communications with the mobile host or that have on-going connection-oriented communications with the mobile host. Accordingly, the MIP-MH daemon 606 maintains the TCP connections cache 612, which is a cache of all the correspondent hosts that have sent TCP messages to the mobile host during the “registration lifetime” of the prior care-of-address that was just updated. Hence, this cache 612 will include not only correspondent hosts that are currently communicating with the mobile host, but also those correspondent hosts that have communicated with the mobile host in the recent past. When the MIP-MH daemon 606 detects a change in the care-of-address, it sends an “update” message to the MIP-CH daemon 614 at each correspondent host listed in the TCP connections cache 612, informing the MIP-CH daemon that the address has changed (step 424). The MIP-CH daemon 614 receives the message and updates its routing cache 618 (and resets the registration lifetime). As such, the mangler module 616 and MIP-CH daemon 614 capture the next packet a connection-oriented application at the correspondent host transmits and use the new care-of-address, allowing the packet to be properly routed to the mobile host and making the change transparent to the application (as shown by block 426). As indicated, the MIP-MH daemon 608 also communicates the change to correspondent hosts that recently communicated with the mobile host. This ensures that a correspondent host that has a routing cache entry for the mobile host due to a past communication does not inadvertently use this stale routing cache entry (because the registration lifetime has not expired) for a new connection oriented application. Note that the MIP-MH daemon 608 and mangler-demangler module 610 continue to operate during the mobile transition as described above, replacing the mobile host's care-of-address with the permanent IP address.

FIG. 8 is a continuation of FIG. 5, showing the integration of MMP and MIP-LR using an exemplary message flow that occurs while the mobile host moves between and within two domains, domain 502 and domain 504, in different sub-networks. Note that MMP message flows from FIG. 5 have been condensed for space purposes. As the mobile host 516a enters domain 502, the MMP daemon obtains a new care-of-address and registers with the domain. The move also causes the MIP-MH daemon at the mobile host 516a to send an “update” message 820 containing the new care-of-address to home location register 510 so that correspondent hosts can locate the mobile host when establishing connection oriented communications. The mobile host 516a and correspondent host 606 then establish a TCP session 804, which requires the MIP-CH daemon at the correspondent host 506 to send a query 806 to the home location register 510 to determine the mobile host's care-of-address. The mobile host and correspondent host then conduct a TCP session 808a, with backbone network 112 routing the packets using traditional IP routing based on the care-of-address and with domain 502 routing the packets using MMP.

As the mobile host moves (538) to domain 504, the MMP daemon at the mobile host obtains a new care-of-address and registers with the domain. The move causes the MIP-MH daemon at the mobile host to send an “update” message 810 to the home location register 510 to update its care-of-address. Because the mobile host 516b and correspondent host 506 have an on-going TCP session, the MIP-MH daemon at the mobile host also sends an “update” message 812 to the MIP-CH daemon at the correspondent host to notify the correspondent host of the change in the care-of-address. Accordingly, the TCP session (now shown as 808b) continues unaffected during the move. Again, the backbone network routes the TCP session packets 808b to domain 504 based on the care-of-address. Routing within domain 504 is based on MMP. Finally, the mobile host 516c moves between base stations within domain 504 (shown by line 548) and the MMP-daemon updates the routing within the domain. However, because the mobile host did not change sub-networks, its care-of-address did not change and the MIP-MH daemon is not activated. Accordingly, the TCP session (now shown by 808c) continues unaffected.

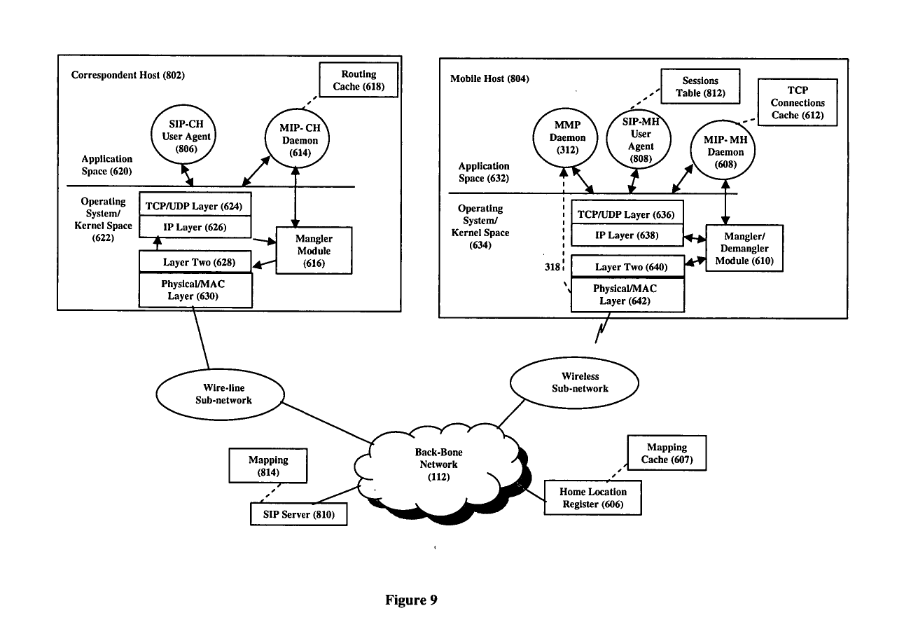

Reference will now be made to the SIP component of our invention. As indicated, SIP manages the real-time communications between the mobile host and correspondent host for real-time applications and essentially operates as described by Henning Schulzrinne and Elin Wedlund in, “Application-Layer Mobility Using SIP” and “Mobility Support using SIP.” FIG. 9 shows a simplified SIP system of our invention comprising a SIP server 810 (note that multiple SIP server architectures can be used for redundancy), a SIP-CH user agent 806 at the correspondent host 802, and a SIP-MH user agent 808 at the mobile host 804. The SIP-MH user agent further comprises a sessions table 812. The real time applications at the mobile and correspondent hosts are assumed to be able to communicate with the SIP-MH user agent 808 and SIP-CH user agent 806. Again, the following assumes the correspondent host 802 is stationary.

As indicated above, under SIP, every host is addressed by a SIP URL. Real-time applications use the SIP URL to address a corresponding host/application and to establish real-time sessions. Hence, the mobile host 804 and correspondent host 802 each have a SIP URL. However, the actual routing of packets between the mobile and correspondent hosts occurs through the mobile host's care-of-address and the correspondent host's permanent IP address. The mapping between the URLs and IP addresses and the updating of the mobile host's care-of-address during mobility occurs through the SIP system.

The SIP server 810 is a server that maintains a mapping 814 between a host's SIP URL and its IP address. While the correspondent host's IP address generally does not change (and as such, the corresponding entry in the SIP server is somewhat static), the mobile host 804 is responsible for updating its current care-of-address at the SIP server as the mobile host moves. Specifically, the SIP-MH user agent 808 at each mobile host 804 periodically monitors the mobile host interface to determine the currently configured IP address. When this address changes, the SIP-MH user agent sends a “SIP invite” message to the SIP server 810, specifying an update (Again, if multiple SIP servers are used, the SIP-MH user agent needs to send a “SIP registration” message to every SIP server when its care-of-address changes.).

When a real-time application at a correspondent host 802 or mobile host 804 needs to originate real-time communications to a corresponding host, the application first communicates with the SIP-CH User agent 806 or SIP-MH user agent 810, respectively, specifying the SIP URL of the corresponding host and requesting the user agent start a SIP session. Assuming it is an application at a correspondent host that is originating the real-time session, the SIP-CH user agent 806 in turn sends a “SIP invite” message to the SIP server 810 to obtain the current care-of-address of the mobile host 804. Having the mobile host's care-of-address, the SIP-CH user agent 806 sends an “Invite” message to the SIP-MH user agent 808, which presumably responds with an “OK” message thereby establishing a SIP session. Both the SIP-CH user agent and SIP-MH user agent then communicate with their corresponding real-time applications, indicating that a new session is established and that real-time communications can begin. Importantly, the mangler module 616 and the mangler-demangler module 610 ignore both the SIP signaling between the SIP user agents 804 and 806 and the RTP/UDP packets flowing between the real-time applications, allowing the packets to move through the network unmodified.

Reference will now be made to how the SIP system allows real-time applications at the correspondent host and mobile host to maintain a SIP session while the mobile host moves and changes its care-of-address, which process is shown in FIG. 4C. As described above, when the mobile host moves and updates its care-of-address through MMP (steps 416-418 of FIG. 4A), the SIP-MH user agent 808 detects the change (step 430) and sends a “SIP invite” message to the SIP server 810 indicating the change and thereby allowing new correspondent hosts to find the mobile host (step 432). However, the SIP-MH user agent 808 also sends the change in address to correspondent hosts that are currently conducting real-time sessions with the mobile host. Accordingly, the SIP-MH user agent 808 maintains the sessions table 812, which is a cache of all the correspondent hosts that have a current real-time sessions with the mobile host. When the SIP-MH user agent 808 detects the change in the care-of-address, it sends a “SIP Re-Invite” message to the SIP-CH user agent 806 at each correspondent host listed in the sessions table 812, informing the SIP-CH user agent that the address has changed (step 434). The SIP-CH user agent in turn notifies the local real-time application of the new care-of-address, which application then uses the address in its continuing communications with the mobile host and thereby allowing the packets to be properly routed (as shown by block 436).

FIG. 10 is a continuation of FIGS. 5 and 8, showing the integration of MMP, MIP-LR, and SIP using the above described exemplary movement of a mobile host 516 as it moves between and within domain 502 and domain 504. Note that the MMP message flows from FIG. 5 and the MIP-LR message flows from FIG. 8 have been condensed for space purposes. As indicated, the mobile host 516a first enters domain 502, causing the MMP daemon to obtain a new care-of-address and register with the domain and causing the MIP-LR daemon to update the home location register 510. The movement into domain 502 also causes the SIP-MH user agent at the mobile host 516a to send an “invite” message 1002 to SIP server 508 to notify correspondent hosts of its new location for the purposes of establishing real-time communications. Assume next that the correspondent host 506 wishes to start a real-time session with the mobile host 516a. Accordingly, the SIP-CH user agent at the correspondent host 506 sends a query 1004 to the SIP server 508 to obtain the mobile host's current care-of-address and then establishes a SIP session 1006 with the mobile host by communicating with the SIP-MH user agent. Based on the established session, the mobile host and correspondent host then conduct an RTP session 1008a, with backbone network 112 routing the RTP packets (and TCP packets 808a) using traditional IP routing based on the care-of-address and with domain 502 routing the packets using MMP.

As the mobile host moves (shown by line 538) to domain 504, the MMP daemon obtains a new care-of-address and registers with the domain, and the MIP-LR daemon updates the home location register 510 and updates the correspondent host 506. Similarly, the movement causes the SIP-MH user agent at the mobile host 516b to send an “invite” message 1010 to the SIP server 508 to update its care-of-address. Because the mobile host 516b and correspondent host 506 have an on-going RTP session, the SIP-MH user agent at the mobile host also sends a “re-invite” message 1012 to the correspondent host to notify it of the change in the care-of-address. Accordingly, the RTP session (now shown as 1008b) continues unaffected by the move. Again, the backbone network routes the TCP session packets 808b and RTP session packets 1008b to domain 504 based on the care-of-address. Routing within domain 504 is based on MMP. Finally, the mobile host 516c moves between base stations within domain 504 (shown by line 548) and the MMP daemon updates the routing within the domain. However, because the mobile host does not change sub-networks, its care-of-address does not change and the SIP-MH user agent at the mobile host, like the MIP-MH daemon, is not activated. Accordingly, the TCP session 808c and the RTP session 1008c continue unaffected.

The above-described embodiments of our invention are intended to be illustrative only. Numerous other embodiments may be devised by those skilled in the art without departing from the spirit and scope of our invention.

We claim:

1. A mobile host that moves both within and between interconnected wireless-access micro-mobility domains, wherein each domain comprises an IP server that provides the mobile host with a temporary care-of-address while the mobile host is present in the domain and which address is used to route packets to and from the domain, and wherein each domain further comprises a plurality of base stations interconnected through a set of nodes that automatically establish up-link and down-link routing paths within the domain to and from the mobile host, said mobile host comprising:
an MMP daemon that monitors the mobile host's movement between base stations and based on broadcast messages from the base stations and the IP server within each domain, determines if the movement is within a domain or to a new domain, wherein if the movement is within the domain said MMP daemon updates a down-link routing path in the domain to the mobile host, and wherein if the movement is to the new domain said MMP daemon establishes a new down-link routing path in the new domain to the mobile host and causes the mobile host to obtain a new care-of-address from the IP server in the new domain;
a first sub-system for managing non-real-time applications at the mobile host wherein said first sub-system captures packets transmitted by the non-real-time applications and changes an originating IP address of the transmitted packets to a permanent IP address associated with the mobile host and further captures received packets intended for the non-real-time applications and changes a destination address of the received packets to the permanent IP address, and wherein said first sub-system monitors for the MMP daemon to change the mobile host's care-of-address and conveys detected changes to corresponding hosts to which the mobile host is conducting non-real-time communications; and
a second sub-system for managing real-time applications at the mobile host wherein said second sub-system monitors for the MMP daemon to change the mobile host's care-of-address and coveys detected changes to corresponding hosts to which the mobile host is conducting real-time communications.
